(19) United States
(12) Patent Application Publication
(10) Pub. No.: US 2026/0112732 A1
(43) Pub. Date: Apr. 23, 2026

(54) THERMAL MANAGEMENT SYSTEM FOR BATTERY PACK

(71) Applicant: GM Global Technology Operations LLC, Detroit, MI (US)

(72) Inventors: Andrew Clay Bobel, Troy, MI (US); Diptak Bhattacharya, Royal Oak, MI (US); William Yu Chen, Troy, MI (US); Anthony Michael Coppola, Rochester Hills, MI (US)

(73) Assignee: GM Global Technology Operations LLC, Detroit, MI (US)

(21) Appl. No.: 18/924,192

(22) Filed: Oct. 23, 2024

(51) Int. Cl. H01M 10/6557; H01M 10/613; H01M 10/625; H01M 10/6551; H01M 50/249

(52) U.S. Cl. CPC H01M 10/6557; H01M 10/613; H01M 10/625; H01M 10/6551; H01M 50/249

(57) ABSTRACT

A thermal management system comprising a plate including a first plate surface and a second plate surface opposite the first plate surface, one or more standoffs coupled to the plate, and one or more cooling channels coupled to the plate. The one or more cooling channels comprising a film layer comprising a first film surface facing and selectively coupled to the plate and a second film surface opposite the first film surface. The thermal management system furthering comprising a fluid arranged between the first film surface and the plate.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to battery packs for electric vehicles and, more particularly, to a thermal management system for battery cells.

Some rechargeable energy storage systems (RESS) can include one or more battery cells and one or more cooling channels arranged between or below the one or more battery cells. Thermal interface material (TIM) is commonly disposed between battery cells and thermal management systems in existing RESS. However, consistent application of TIM can be difficult and, thus, thermal performance of existing RESS can vary. Shortcomings of existing systems are addressed by one or more aspects of the present disclosure.

### SUMMARY

In one configuration, a thermal management system is provided and includes a plate including a first plate surface and a second plate surface opposite the first plate surface, one or more standoffs coupled to the plate, and one or more cooling channels coupled to the plate. The one or more cooling channels include a film layer, including a first film surface facing and selectively coupled to the plate and a second film surface opposite the first film surface. The thermal management system further includes a fluid arranged between the first film surface and the plate.

The thermal management system may include one or more of the following optional aspects. For example, the one or more standoffs can be coupled to the first plate surface. The one or more standoffs can be coupled to the second plate surface.

According to at least one aspect, the film layer can be coupled to the first plate surface.

According to another aspect, the film layer can include a first film layer and a second film layer, the first film layer can be coupled to the first plate surface and defines a first cooling pathway, and the second film layer can be coupled to the second plate surface and defines a second cooling pathway.

According to at least one example, the film layer cam include one or more bonded regions and one or more unbonded regions.

According to another example, the film layer can include one or more contact surfaces that face away from the first plate surface.

According to at least one aspect, the fluid can be a coolant.

According to another aspect, the film layer can include a first shape at a first pressure and a second shape at a second pressure. The first pressure can be about 1 pound per square inch (psi) and the second pressure can be between 15 and 30 psi.

In another configuration, a battery pack is provided and includes one or more battery cells and a thermal management system. The thermal management system includes a plate including a first plate surface and a second plate surface opposite the first plate surface, one or more standoffs coupled to the plate and the one or more battery cells, and one or more cooling channels. The one or more cooling channels include a film layer including a first surface facing and selectively coupled to the plate and a second surface opposite the first surface and facing the one or more battery cells. The thermal management system further including a fluid arranged between the first surface of the film layer and the plate.

The battery pack may include one or more of the following optional aspects. For example, the cooling channels consume at least half of a surface area of the first plate surface or the second plate surface.

According to at least one aspect, the film layer includes contact surfaces that engage with the one or more battery cells. The contact surfaces define one or more thermal pathways between the one or more battery cells and the cooling channels.

According to another aspect, the film layer includes a plastic-coated aluminum material.

In yet another configuration, a vehicle is provided and includes a vehicle body including a first end, a second end spaced from the first end, a first side, and a second side spaced from the first side. The vehicle further includes a motor coupled to the vehicle body and a battery pack coupled to the vehicle body and communicatively coupled to the motor. The battery pack includes one or more battery cells and a thermal management system. The thermal management system includes a plate, one or more standoffs coupled to the plate and the one or more battery cells, and one or more cooling channels including a film layer having a first surface facing and selectively coupled to the plate and a second surface opposite the first surface and engaging with the one or more battery cells. The thermal management system further including a fluid arranged between the first surface of the film layer and the plate.

The vehicle may include one or more of the following optional aspects. For example, the vehicle further includes one or more thermal pathways between the one or more battery cells and the thermal management system.

According to at least one aspect, at least one of the one or more standoffs is arranged between the one or more cooling channels.

According to another aspect, the one or more standoffs are an integral part of the plate or the one or more battery cells.

According to at least one example, the film layer includes a plastic-coated aluminum material.

### BRIEF DESCRIPTION OF THE DRAWINGS

The drawings described herein are for illustrative purposes only of selected configurations and are not intended to limit the scope of the present disclosure.

FIG. 1 is a front perspective view of a vehicle including a battery pack and a motor according to principles of the present disclosure;

FIG. 2 is a front perspective view of a battery cell of the battery pack of FIG. 1;

FIG. 3 is a top perspective view of the battery pack of FIG. 1 including a thermal management system according to principles of the present disclosure;

FIG. 4 is a cross-sectional view of the battery pack of FIG. 3 along line 4-4;

FIG. 5 is a cross-sectional view of the battery pack of FIG. 3 including one or more cooling channels;

FIG. 6 is a cross-sectional view of another configuration of the battery pack of FIG. 1 according to the principles of the present disclosure;

FIG. 7 is a cross-sectional view of another configuration of a battery pack according to the principles of the present disclosure; and

FIG. 8 is a cross-sectional view of another configuration of a battery pack according to the principles of the present disclosure.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Some rechargeable energy storage systems (RESS) use thermal interface materials (TIM) to fill air gaps (i.e., micro or macro) between one or more battery cells and a plate. TIM can be used to regulate temperature of the one or more battery cells. However, consistent application of TIM can be challenging and, thus, thermal performance of RESS can vary. Accordingly, these shortcomings, among others, are addressed by principles of the present disclosure.

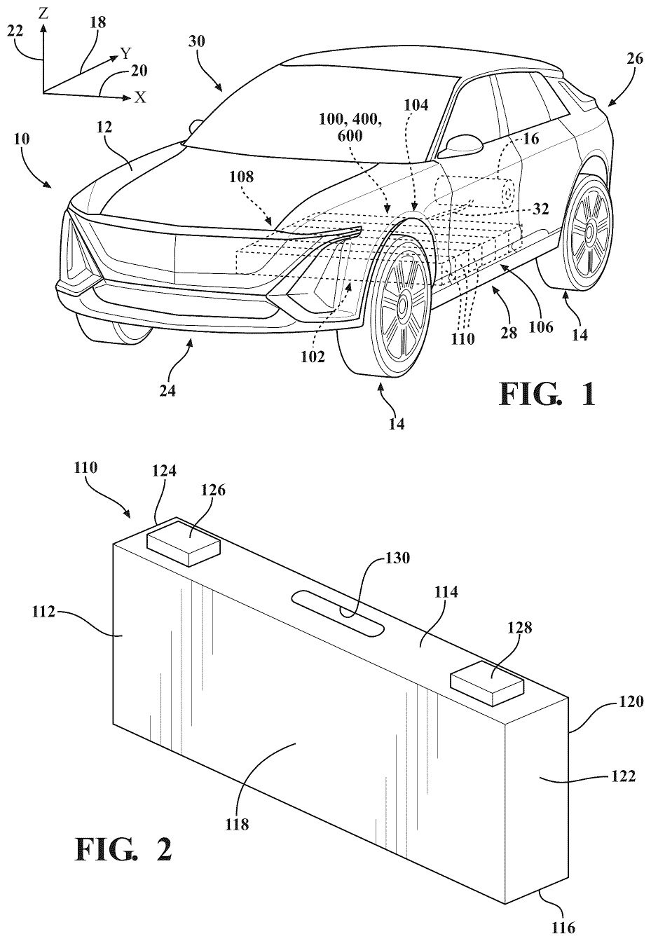

With reference to FIG. 1, a vehicle 10, such as an electric motor vehicle, is provided. The vehicle 10, includes a vehicle body 12, one or more wheels 14 coupled to the vehicle body 12, and an electric motor 16 arranged in and/or coupled to the vehicle body 12. The vehicle body 12 extends along a first or longitudinal axis (i.e., fore-aft direction) 18, a second or lateral axis (i.e., cross-car direction) 20, and a third or vertical axis 22. The vehicle body 12 can include a first or front end 24, a second or rear end 26 spaced from the front end 24 with respect to the longitudinal axis 18, a first or left side 28, and a second or right side 30 spaced from the left side 28 with respect to the lateral axis 20. The electric motor 16 can be configured to drive one or more of the one or more wheels 14 to propel the vehicle 10. The vehicle 10 includes a battery pack 100 that can be arranged in and/or coupled to the vehicle body 12 and is communicatively coupled to the electric motor 16 via an electric power cable 32.

With continued reference to FIG. 1, the battery pack 100 extends at least along the longitudinal axis 18 and the lateral axis 20. The battery pack 100 can have a first or front end 102, a second or rear end 104 spaced from the front end 102 with respect to the longitudinal axis 18, a first or left side 106, and a second or right side 108 spaced from the left side 106 with respect to the lateral axis 20. In the present illustrative example, the battery pack 100 includes one or more battery cells 110 arranged between the front end 102 and the rear end 104.

With reference to FIG. 2, an illustrative example of one of the one or more battery cells 110 is provided. In the present illustrative example, the one or more battery cells 110 are prismatic battery cells, however, the principles of the present disclosure can equally apply to other types of battery cells, such as cylindrical battery cells. The one or more battery cells 110 can each include a prismatic can 112 that extends between a first or upper end 114 and a second or lower end 116. The prismatic can 112 includes one or more side walls, such as a first side wall 118 and a second side wall 120 spaced from the first side wall 118. Additionally, the prismatic can 112 includes a first end wall 122 and a second end wall 124. In the present example, the first and second side walls 118, 120 have a length that is longer than that of the first and second end walls 122, 124. The prismatic can 112 is configured to house battery internals, such as one or more jelly rolls (not shown). The one or more battery cells 110 include terminals coupled to the upper end 114 and in communication with the battery internals. The terminals can include a positive terminal 126 and a negative terminal 128, for example. In the present illustrative example, the prismatic can 112 includes a vent 130 that is arranged at the upper end 114 and between the positive terminal 126 and the negative terminal 128.

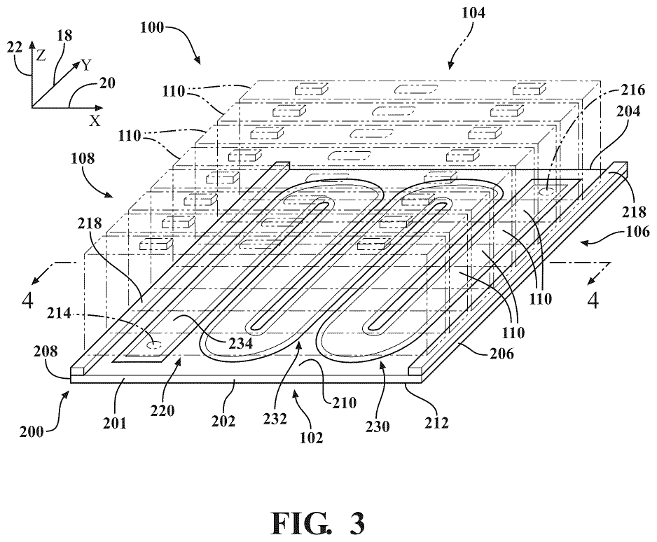

With reference to FIG. 3, the battery pack 100 can further include a thermal management system 200 arranged with respect to the one or more battery cells 110. The thermal management system 200 includes a plate (i.e., cold plate) 201 that extends between the front and rear ends 102, 104 and between the first and second sides 106, 108 of the battery pack 100. The plate 201 includes a first end 202, a second end 204 spaced from the first end 202, a first side 206, and a second side 208 spaced from the first side 206. The first end 202 can be arranged adjacent to the front end 102 of the battery pack 100 and the second end 204 can be arranged adjacent to the rear end 104 of the battery pack 100. The plate 201 includes a first or upper surface 210 and a second or lower surface 212 opposite the upper surface 210. In the present illustrative configuration, the upper surface 210 faces the lower ends 116 of the one or more battery cells 110. One or more conduits can be arranged in the plate 201 and extend through the upper and lower surfaces 210, 212 of the plate 201. The one or more conduits can include an inlet 214 and an outlet 216. In some configurations, the inlet 214 and the outlet 216 are arranged on the same side or same end of the plate 201 and, in other configurations, the inlet 214 and the outlet 216 are arranged on opposite sides or ends of the plate 201, as shown in FIG. 3. The plate 201 can be metallic (e.g., aluminum, steel, etc.) or plastic (e.g., injection molded). Passivation or conversion using silane, Alodine®, and/or another material can be utilized to clean or form one or more film coatings on the one or more surfaces of the plate 201. Additionally or alternatively, plasma treatment or laser ablation of one or more surface can be used to enhance and/or improve adhesion between the plate 201 and another component of the thermal management system 200, for example. According to one aspect, the plate 201 can have a thickness 217 between 0.5 and 2 millimeters (mm).

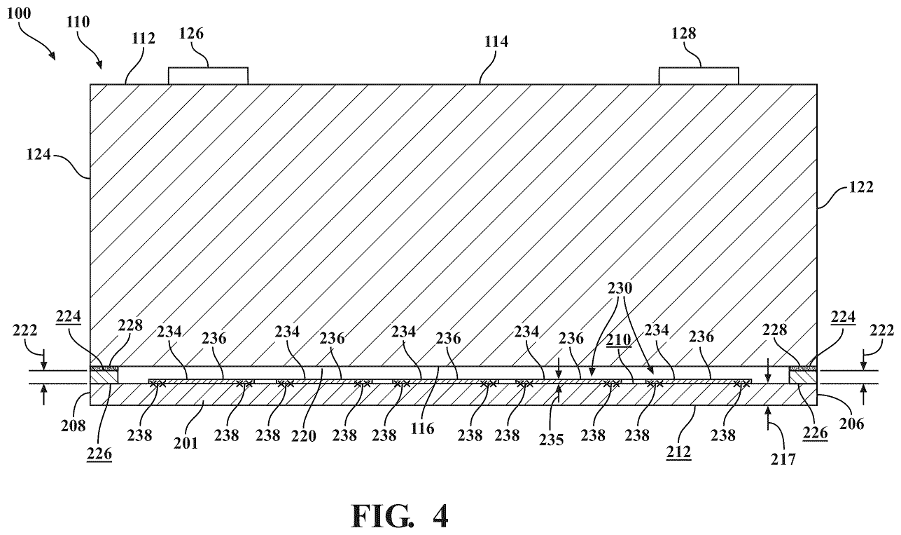

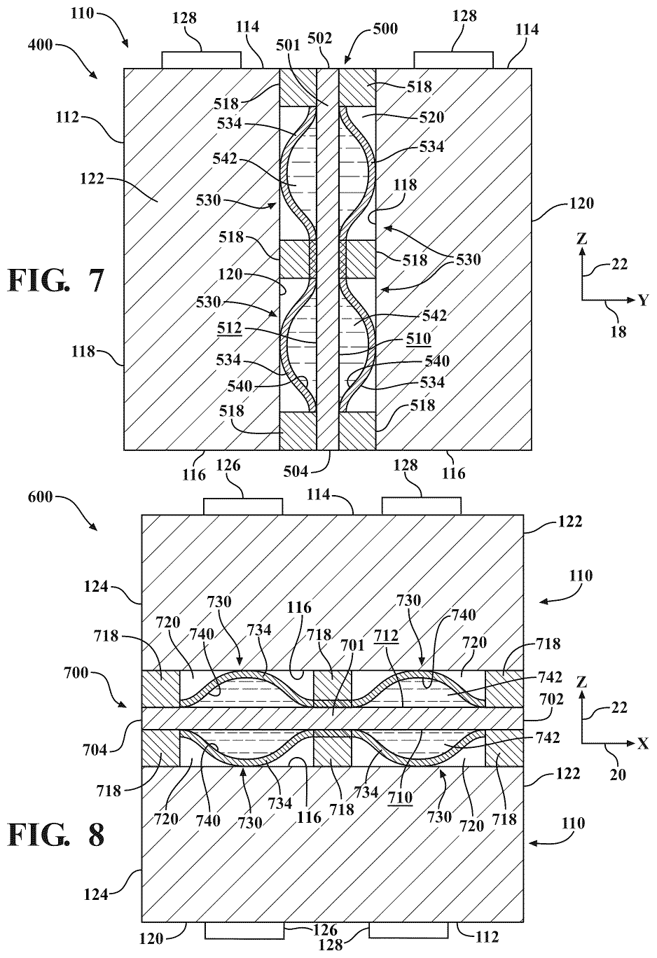

With continued reference to FIG. 3, the thermal management system 200 can include one or more standoffs 218 arranged between the one or more battery cells 110 and the plate 201. In general, the one or more standoffs 218 can be configured to establish and/or maintain separation between a portion of the plate 201 and the one or more battery cells 110. A gap or chamber 220 is formed between the plate 201 and the one or more battery cells 110. With reference to FIG. 4, the gap 220 can be defined by a thickness 222 between a first or top surface 224 and a second or bottom surface 226 opposite the top surface 224. According to one aspect, the thickness 222 of the one or more standoffs 218 can be between 1 and 2 millimeters (mm). The one or more standoffs 218 can be arranged adjacent to or at the first and second sides 206, 208 and extend between the first end 202 and the second end 204 of the plate 201. In some configurations, the one or more standoffs 218 can include one or more points (e.g., circles, squares, etc.) rather than the linear arrangement shown in the illustrative configuration of FIG. 3. The bottom surface 226 of the one or more standoffs 218 can be coupled to or otherwise attached to a portion of the upper surface 210 of the plate 201. In some configurations (FIGS. 7 and 8), as will be discussed in more detail below, the one or more standoffs 218 can also be arranged on the lower surface 212 of the plate 201 as well. The top surface 224 of the one or more standoffs 218 can be coupled to or otherwise attached to a portion of the lower end 116 of the prismatic can 112 of the one or more battery cells 110. An adhesive, heat welding, laser welding, spot welding, TIG welding, or another coupling technique commonly used in manufacturing automotive battery cells may be used to couple or otherwise attach the one or more standoffs 218 to the plate 201 and/or to the one or more battery cells 110. In another configuration, at least one of the one or more standoffs 218 can be an integral component of the plate 201. For instance, at least one of the one or more standoffs 218 can be formed with the plate 201 during an injection molding process. In another configuration, at least one of the one or more standoffs 218 are either an integral portion, coupled to, or otherwise attached to the lower end 116 of the prismatic can 112. For example, at least one of the one or more standoffs 218 can be metallic and can be welded via a laser to a portion of the prismatic can 112. For instance, in the present illustrative example, an adhesive 228 is arranged between the top surface 224 of the one or more standoffs 218 and the one or more battery cells 110.

With continued reference to FIG. 3, the thermal management system 200 includes one or more cooling channels (hereinafter, the cooling channels) 230 arranged on the upper surface 210 of the plate 201. As discussed in more detail below with respect to other configurations, the cooling channels 230 can also be arranged on the lower surface 212 of the plate 201. The cooling channels 230 can be communicatively coupled to the one or more conduits (e.g., the inlet 214 and outlet 216) and arranged in a serpentine path (FIG. 3) 232, in parallel columns, or in another configuration. According to one aspect, the cooling channels 230 can consume more than half of the surface area of the upper surface 210. The cooling channels 230 include a film layer 234 that can be coupled to or otherwise attached to the upper surface 210 of the plate 201. The film layer 234 can be plastic-coated aluminum, for example. Alternatively, the film layer 234 can be made of polyamide (PA), polyphthalamide (PPA), polypropylene (PP), polyurethane (PU), polyethylene terephthalate (PET), etc. The film layer 234 can be coupled to the plate 201 using impulse heat sealing, heat stamping, heat rolling, laser, or infrared light, for example. According to one aspect, the film layer 234 can include a thickness 235 that is between 40 and 200 micrometers (um). Upon assembly, the film layer 234 includes a one or more unbonded regions 236 and one or more bonded regions 238.

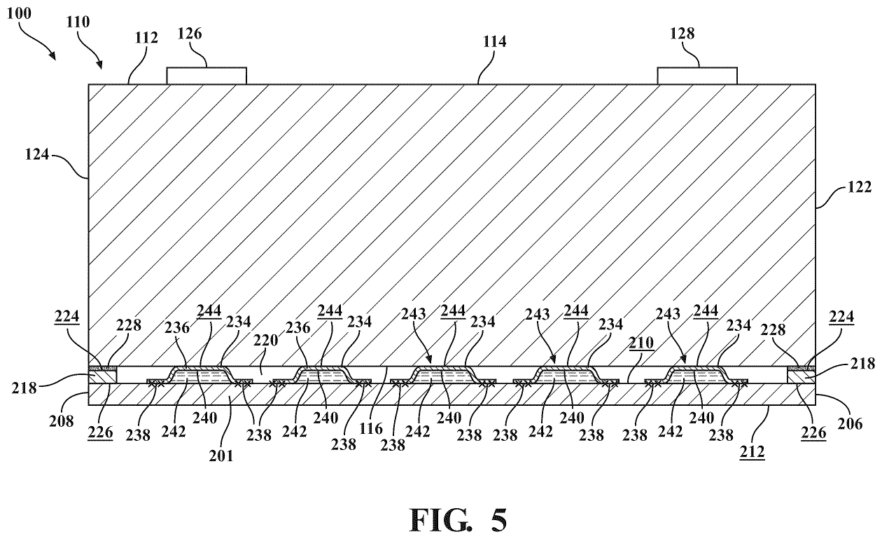

With reference to FIG. 5, a coolant pathway 240 can be defined between the one or more unbonded regions 236, the one or more bonded regions 238, and the plate 201. A fluid, such as a coolant 242 (e.g., a blend of Dexcool® and water, ethylene glycol/water-based coolants, hydrocarbon oils, silicone oils, ethers, fluorocarbon oils, etc.), can be arranged in the coolant pathway 240 to inflate the film layer 234, as shown in FIG. 5. An operating pressure can be between 100-200 kilopascals (kPa) or 15-30 pounds per square inch (psi). The operating pressure applies an outward force away from the plate 201 so that the contact surfaces 244 of the film layer 234 directly engage with or press against the one or more battery cells 110. In other words, one or more thermal pathways 243 are established between the film layer 234 and the one or more battery cells 110 upon inflation, which eliminates the need for TIM. This can be desirable because TIM can be expensive and/or can add a considerable amount of weight to existing RESS. According to one configuration, prior to inflation, an adhesive can be applied to the one or more contact surfaces 244 so that the film layer 234 adheres to the one or more battery cells 110 upon inflation. In another configuration, a minimum pressure (e.g., 1 psi) can be maintained within the cooling pathways 240 so that the film layer 234 has a minimum set shape. This can be desirable so that the cooling channels 230 can easily inflate during operation, for example.

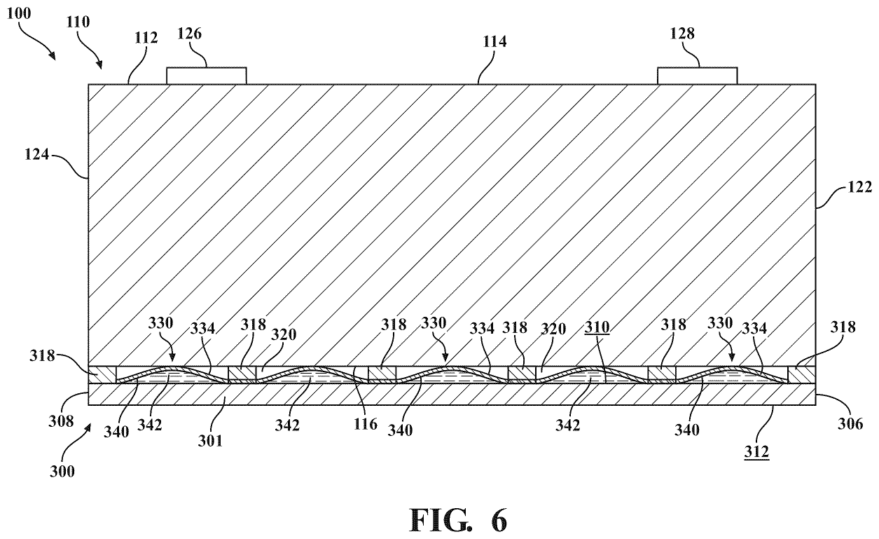

FIG. 6 illustrates another illustrative configuration of a thermal management system 300. This configuration is similar in many respects to the configuration of FIGS. 1-5. Accordingly, the descriptions of the configurations are hereby incorporated into one another, and description of subject matter common to the configurations generally may not be repeated.

With reference to FIG. 6, the thermal management system 300 includes a plate 301 that extends between a first side 306 and a second side 308. A first or upper surface 310 and a second or lower surface 312 each extend between the first side 306 and the second side 308. One or more standoffs 318 are coupled to the upper surface 310 between the first side 306 and the second side 308 and maintain a gap or chamber 320 between the plate 301 and one or more battery cells 110. One or more cooling channels 330 are arranged in the gap 320. More particularly, the cooling channels 330 include a film layer 334 coupled to or otherwise attached to the upper surface 310 of the plate 301. A cooling pathway 340 is defined between the film layer 334 and the plate 301 and is configured to receive and carry a fluid, such as a coolant 342. In the present illustrative configuration, the one or more standoffs 318 are arranged between the cooling channels 330. This can be desirable to maintain the gap 320 so that the film layer 334 and, more specifically, the cooling pathway 340 is not crushed during or after operation, for example.

FIG. 7 illustrates another illustrative configuration of a battery pack 400. This configuration is similar in many respects to the configuration of FIGS. 1-5 and FIG. 6. Accordingly, the descriptions of the configurations are hereby incorporated into one another, and description of subject matter common to the configurations generally may not be repeated.

With reference to FIG. 7, the battery pack 400 includes a thermal management system 500 arranged between the one or more battery cells 110 with respect to the lateral axis 20. The thermal management system 500 includes a plate 501 having a first end 502 and a second end 504 opposite the first end 502. A first side surface 510 extends between the first end 502 and the second end 504 and faces the first side wall 118 of at least one of the one or more battery cells 110. A second side surface 512 is arranged opposite of the first side surface 510 and extends between the first end 502 and the second end 504. Additionally, the second side surface 512 faces the second side wall 120 of at least one of the one or more battery cells 110.

With continued reference to FIG. 7, one or more standoffs 518 are coupled to or otherwise attached to the first side surface 510 and the second side surface 512 of the plate 501. The one or more standoffs 518 establish and/or maintain a gap 520 between the one or more battery cells 110 and the first and second side surfaces 510, 512.

With reference again to FIG. 7, one or more cooling channels 530 can be arranged within the gap 520 between the one or more battery cells 110 and the first and second side surfaces 510, 512. The one or more cooling channels 530 include a film layer 534 that is attached or otherwise coupled to the first and second side surfaces 510, 512. The film layer 534 can be selectively coupled or otherwise attached to the plate 501 to define one or more cooling pathways 540. A fluid, such as a coolant 542, can be circulated within the cooling pathways 540 so that a portion of the film layer 534 engages with and/or contacts the one or more battery cells 110, for example.

FIG. 8 illustrates another illustrative configuration of a battery pack 600. This configuration is similar in many respects to the configuration of FIGS. 1-5, FIG. 6, and FIG. 7. Accordingly, the descriptions of the configurations are hereby incorporated into one another, and description of subject matter common to the configurations generally may not be repeated.

With reference to FIG. 8, the battery pack 600 includes a thermal management system 700 arranged between the one or more battery cells 110 with respect to the vertical axis 22. The thermal management system 700 includes a plate 701 having a first end 702 and a second end 704 opposite the first end 702 with respect to the lateral axis 20. A first side surface 710 extends between the first end 702 and the second end 704 and faces the lower end 116 of at least one of the one or more battery cells 110. A second side surface 712 is arranged opposite the first side surface 710 and extends between the first end 702 and the second end 704. Additionally, the second side surface 712 faces the lower end 116 of another one of the one or more battery cells 110. In other words, the thermal management system is sandwiched between the lower ends 116 of two or more of the battery cells 110 along the longitudinal axis (extending into the page).

With continued reference to FIG. 8, one or more standoffs 718 are coupled to or otherwise attached to the first side surface 710 and the second side surface 712 of the plate 701. The one or more standoffs 718 establish and/or maintain a gap 720 between the one or more battery cells 110 and the first and second side surfaces 710, 712.

With reference again to FIG. 8, one or more cooling channels 730 can be arranged within the gap 720 between the one or more battery cells 110 and the first and second side surfaces 710, 712. The one or more cooling channels 730 include a film layer 734 that is attached or otherwise coupled to the first and second side surfaces 710, 712. The film layer 734 can be selectively coupled or otherwise attached to the plate 701 to define one or more cooling pathways 740. A fluid, such as a coolant 742, can be circulated within the cooling pathways 740 so that a portion of the film layer 734 engages with and/or contacts the one or more battery cells 110 and, more particularly, the portion of the lower ends 116, for example.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A thermal management system, comprising:
a plate including a first plate surface and a second plate surface opposite the first plate surface;
one or more standoffs coupled to the plate;
one or more cooling channels coupled to the plate, comprising:
a film layer, comprising:
a first film surface facing and selectively coupled to the plate, and
a second film surface opposite the first film surface; and
a fluid arranged between the first film surface and the plate.

2. The thermal management system of claim 1, wherein the one or more standoffs are coupled to the first plate surface.

3. The thermal management system of claim 2, wherein the one or more standoffs are coupled to the second plate surface.

4. The thermal management system of claim 1, wherein the film layer is coupled to the first plate surface.

5. The thermal management system of claim 1, wherein the film layer includes a first film layer and a second film layer, the first film layer is coupled to the first plate surface and defines a first cooling pathway, and the second film layer is coupled to the second plate surface and defines a second cooling pathway.

6. The thermal management system of claim 1, wherein the film layer includes one or more bonded regions and one or more unbonded regions.

7. The thermal management system of claim 1, wherein the film layer includes one or more contact surfaces that face away from the first plate surface.

8. The thermal management system of claim 1, wherein the fluid is a coolant.

9. The thermal management system of claim 1, wherein the film layer includes a first shape at a first pressure and a second shape at a second pressure.

10. The thermal management system of claim 9, wherein the first pressure is about 1 pound per square inch (psi) and the second pressure is between 15 and 30 psi.

11. A battery pack, comprising:
one or more battery cells; and
a thermal management system, comprising:
a plate including a first plate surface and a second plate surface opposite the first plate surface,
one or more standoffs coupled to the plate and the one or more battery cells, one or more cooling channels, comprising:
a film layer, including:
a first surface facing and selectively coupled to the plate, and
a second surface opposite the first surface and facing the one or more battery cells, and
a fluid arranged between the first surface of the film layer and the plate.

12. The battery pack of claim 11, wherein the cooling channels consume at least half of a surface area of the first plate surface or the second plate surface.

13. The battery pack of claim 11, wherein the film layer includes contact surfaces that engage with the one or more battery cells.

14. The battery pack of claim 13, wherein the contact surfaces define one or more thermal pathways between the one or more battery cells and the cooling channels.

15. The battery pack of claim 11, wherein the film layer includes a plastic-coated aluminum material.

16. A vehicle, comprising:
a vehicle body including a first end, a second end spaced from the first end, a first side, and a second side spaced from the first side;
a motor coupled to the vehicle body; and
a battery pack coupled to the vehicle body and communicatively coupled to the motor, the battery pack comprising:
one or more battery cells; and
a thermal management system, comprising:
a plate,
one or more standoffs coupled to the plate and the one or more battery cells,
one or more cooling channels, comprising:
a film layer, including:
a first surface facing and selectively coupled to the plate, and
a second surface opposite the first surface and engaging with the one or more battery cells, and
a fluid arranged between the first surface of the film layer and the plate.

17. The vehicle of claim 16, wherein the battery pack further includes one or more thermal pathways between the one or more battery cells and the thermal management system.

18. The vehicle of claim 16, wherein at least one of the one or more standoffs is arranged between the one or more cooling channels.

19. The vehicle of claim 16, wherein the one or more standoffs are an integral part of the plate or the one or more battery cells.

20. The vehicle of claim 16, wherein the film layer includes a plastic-coated aluminum material.
